(19) United States
(12) Patent Application Publication
(10) Pub. No.: US 2024/0316749 A1
(43) Pub. Date: Sep. 26, 2024

(54) ARRANGEMENT COMPRISING A RECEIVING DEVICE FOR REMOVABLE ATTACHMENT OF A SCREW BIT HOLDER AND A RECEIVING DEVICE

(71) Applicant: ANDERS JAKOBSSON ROR AB, Skogas (SE)

(72) Inventor: Anders Jakobsson, Farsta (SE)

(73) Assignee: ANDERS JAKOBSSON ROR AB, Skogas (SE)

(21) Appl. No.: 18/562,649

(22) PCT Filed: Jun. 10, 2022
(86) PCT No.: PCT/SE22/50576

§ 371 Date: Nov. 20, 2023

(30) Foreign Application Priority Data
Jun. 14, 2021 (SE) 2150767-8

(51) Int. Cl. B25H 3/00; B25F 5/02

(52) U.S. Cl. CPC B25H 3/003; B25F 5/029

(57) ABSTRACT

A receiving device for removable attachment of a screw bit holder includes a disc-shaped platform, made of magnetic material or provided with at least one magnetic element, and a centrally extending projection. The screw bit holder includes a base portion with apertures for carrying screw bits. The screw bit holder has at least one magnetic element adjacent the bottom of the apertures. The back side of the screw bit holder includes with a cavity that has a removable attachment of the centrally extending projection. The magnetic elements are positioned adjacent each other such that the screw bit holder and the receiving device are removably attached to each other by the magnetic force.

### TECHNICAL FIELD

The invention relates to an arrangement comprising a receiving device for removable attachment of a screw bit holder and a receiving device.

### BACKGROUND

The invention is advantageously used as an accessory for an electric screwdriver.

In conventional construction operations by craftsmen, by non-professionals and professional craftsmen such as carpenters, plumbers or the similar, many different screw fastenings means are used for various construction and repair. Today, it is common to use an electric screw driver when carrying out the work with a set of various screwdriver bits adapted for different heads of the screw fastening means. Some of the most common screw heads are among others the slot head, the phillips head, the torx drive and the square drive. The other end of the bits usually has a hex shank and are adapted to fit in to most screw drivers chucks with a corresponding hex recess for the hex shank.

Consequently, there may be a lot of different screwdriver bits that the craftsmen need to have easily available and immediately ready to be used during the specific work situation. A usual work situation for a craftsman may be when he/she is in a position not able for easily access to any large storage of different screw driver bit, for instance when standing on a ladder during the use of the screw driver, working in confined spaces such as on the back underneath a car etc. There is usually no time and cumbersome to look for the specific screwdriver bit that you need at a specific point of time, especially if you are a professional craftsman, it is time-consuming and not cost efficient. Hence, it is cumbersome to locate the correct bits to be used and to store the bits that are not used for the moment, in an organized manner in order to be quickly available when needed. A further problem is the potential risk that you may lose bits if they are not stored in a safe and orderly way.

Over the years, there have been many efforts with respect to the handling of screwdriver bits and to solve the problem with storing the bits in an organized and accessible way in order to, at any given time, have the specific bit ready for use that is required in the work in question.

There is a desire to improve the accessibility of bits when they are needed in the work situation and to easily locate the specific and correct bit for the work. There is also a desire to simplify the storage of bits that are not used at the moment. Doing this may decrease time-consuming localization of bits and make the work for the craftsman less cumbersome.

There is also a desire to find an alternative instead of using one single large common storage container for all bits that a craftsman may have in his possession, used for a screw driver.

A further desire is to eliminate the risk for loosing bits during handling and storage.

U.S. Pat. No. 8,474,615 B2 relates to a retention dual use bit holder. A magnetic member is optionally engaged to the base of the bit holder. The magnetic member allows the base to be removably attached to a metallic surface for storage.

DE 102011116422 A1 relates to a bit-screw tool that has bit- and drill magazine fastened at shaft, in which multiple bits and drills are inserted, where magazine has magnetic base, which is strongly designed such that all bits and drills remain plugged in.

U.S. Pat. No. 6,752,268 B1 relates to a drill bit holder which mounts directly on a drill makes drill bits readily accessible to a user.

U.S. Pat. No. 6,739,226 B2 relates to a stationary bit holder comprising a drill attachment for use with a drill chuck includes a shaft adapted at one end for releasably mounting to the drill chuck, and at the other end for releasably mounting tool bits therein. A housing is connected operably to said shaft, said housing defining bit compartments for releasably receiving tool bits therein.

### SUMMARY

An object of the invention is to improve the accessibility of bits when they are needed in the work situation. Another object of the invention is to simplify the storage of bits that are not used at the moment, but still easily available, in a given work situation. A further object is to be able to provide suitable storage devices for the bits, that can be handled individually, and that simplify the handling and immediate accessibility of the bits that is needed in a given work situation. Another object of the invention is to provide a system for the bit storage devices, including at least one screw bit holder carrying several bits, intended for removable attachment on an electric screw driver, which make it possible to handle the bit storage devices easy to and from the screw driver. Yet a further object is to decrease the risk for losing any bits during work when handling the tools and materials, in particular when using the screw driver, while changing bits.

The objects are achieved by an arrangement according to claim 1. Thus, the objects are achieved by an arrangement comprising a receiving device for removable attachment of a screw bit holder. The receiving device comprises a disc-shaped platform having a front side and a back side, provided with a centrally extending projection, protruding essentially perpendicular from the front side of the disc-shaped platform of the receiving device. At least a part of the disc-shaped platform is made of a magnetic material or at least a part of a surface surrounding the projection is provided with at least one magnetic element. The screw bit holder comprises a base portion with apertures at a front side of the screw bit holder for carrying screw bits. The screw bit holder is provided with at least one magnetic element adjacent the bottom of the apertures towards a back side of the screw bit holder. The back side of the screw bit holder is provided with a cavity configured for removable attachment of the centrally extending projection of the receiving device, whereas the magnetic elements on the receiving device, or the magnetic platform of the receiving device, and the screw bit holder are positioned adjacent each other such that the screw bit holder and the receiving device are removable attached to each other by the magnetic force.

As a result, a simplified and easily accessible handling of bits can be provided. The screw bit holders are quickly interchangeable, by moving the screw bits holders to and from a storage position for attachment or detachment at an electrical screw driver. Thanks to the magnetic attachment between the receiving device and the screw bits holder, it is also quick and easy to remove the screw bits holder from the receiving device by overcoming the magnetic force exerted by the magnets. A further advantage is that screw bits holders comprising a plurality of bits that are not in use for the moment can be stored in an organized and easily accessible way, in order to be ready for use by quick attachment in a position on the electrical screw driver. Once a screw bits holder is in its position on the electrical screw driver, the user is as close as possible to the suitable bits in the specific work situation and may easily choose among the bits and change to the desired one for carrying out the work.

According to an aspect of the invention, the platform is circular, preferably provided with a continuous circular magnetic element surrounding the projection. Most preferably, the platform is made of magnetic material. A circular platform is easier to fit with a surface of a connecting device with corresponding circular shape, than non-circular forms. This is an advantage from a handling point of view, also with respect to the preferred form of the magnetic element, as well as from an efficient production point of view.

According to a further aspect of the invention, the cavity of the screw bit holder is a through longitudinal hole and the centrally extending projection, protruding essentially perpendicular from the disc-shaped platform of the receiving device, is a bit holder axle, preferably a standardized bit holder axle, extending in the through longitudinal hole. Thanks to the adaption of the arrangement that can be used in existing equipment on the market, the user can use his/her old screw driver and preferably also a standardized bit holder axle.

According to a further aspect of the invention, the platform is removable attached to the centrally extending projection, preferably a standardized bit holder axle, and the platform has a centrally through hole which diameter is less than the largest diameter of the centrally extending projection. This result in an uncomplicated and simplified handling when providing the receiving device with the platform, removable attached to the centrally extending projection, preferably a standardized bit holder axle. When the receiving device e.g. is mounted on an electric screw driver, the larger diameter of the centrally extending projection, preferably a standardized bit holder axle, prevents the platform to move further forward on the axle.

According to yet a further aspect of the invention the receiving device is configured for removable attachment to a drill chuck of an electric screw driver. Although, other applications for the receiving device are possible, the receiving device is specifically suitable for attachment to a drill chuck of an electric screw driver.

According to another aspect of the invention, a storage device for bits is provided with at least one receiving device, configured for removable attachment of a screw bit holder, wherein the receiving device is firmly attached to a supporting surface, either adjacent a portion of the side of the disc-shaped platform or at the backside of the disc-shaped platform. As a result, storage devices for the bits can be provided, that can be handled individually, and that simplify the handling and immediate accessibility of the bits that is needed in a given work situation. Hence, screw bits holders comprising a plurality of bits that are not in use for the moment can be stored in an organized and easily accessible way, in order to be ready for use by quick attachment in a position on the electrical screw driver.

According to yet another aspect of the invention, a receiving device for removable attachment of a screw bit holder is provided, wherein the receiving device comprises a disc-shaped platform provided with a centrally extending projection, at a front side of the disc-shaped platform, protruding essentially perpendicular from the disc-shaped platform of the receiving device. At least a part of the disc-shaped platform is made of a magnetic material, or at least a part of a surface surrounding the projection is provided with at least one magnetic element. An advantage with providing a receiving device, for removable attachment of a screw bit holder, with a disc-shaped magnetic platform, is that a bit holder axle, preferably a standardized bit holder axle, can be easily adapted for removable magnetic connection with a screw bit holder.

According to another aspect of the invention, wherein a receiving device for removable attachment of a screw bit holder is provided, an opposite back side of the disc-shaped platform is provided with fastening means, preferably a keychain or a hook or the similar, whereas the centrally extending projection is configured for removable attachment to a cavity at a back side of a screw bit holder. The advantage is that the receiving device can be used for storing screw bit holders close to the workman, for instance carried on a belt or attached to a structure close to the workman during ongoing work.

Further advantages and advantageous features of the invention are disclosed in the following description and in the dependent claims.

### BRIEF DESCRIPTION OF THE DRAWINGS

Below, embodiments of the invention will be described with reference to the drawings, in which:

FIG. 1 shows in a transparent and exploded perspective view an arrangement comprising a receiving device for removable attachment of a screw bit holder according to an embodiment of the invention,

FIG. 2 illustrates in a transparent perspective view the receiving device for removable attachment of the screw bit holder of the arrangement in FIG. 1,

FIG. 3 shows the screw bit holder in a perspective view as illustrated in FIGS. 1 and 2,

FIG. 4 shows in a cross-sectional and exploded side view the screw bit holder as illustrated in FIGS. 1-3,

FIG. 5 shows a perspective view a disc-shaped platform of the receiving device shown in FIGS. 1, 2 and 4,

FIG. 6 shows in a perspective view a storage device for screw bit holders, according to another embodiment of the invention, and

FIG. 7A-B shows in a partially cross-sectional side view a receiving device in a connected condition and in a disconnected condition, according to yet another embodiment of the invention.

### DETAILED DESCRIPTION OF EMBODIMENTS OF THE INVENTION

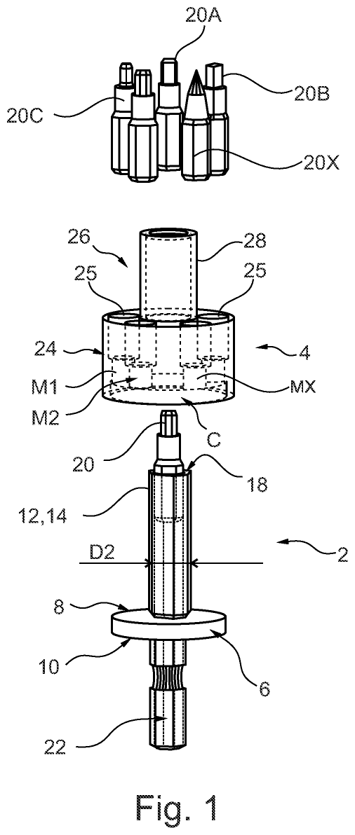

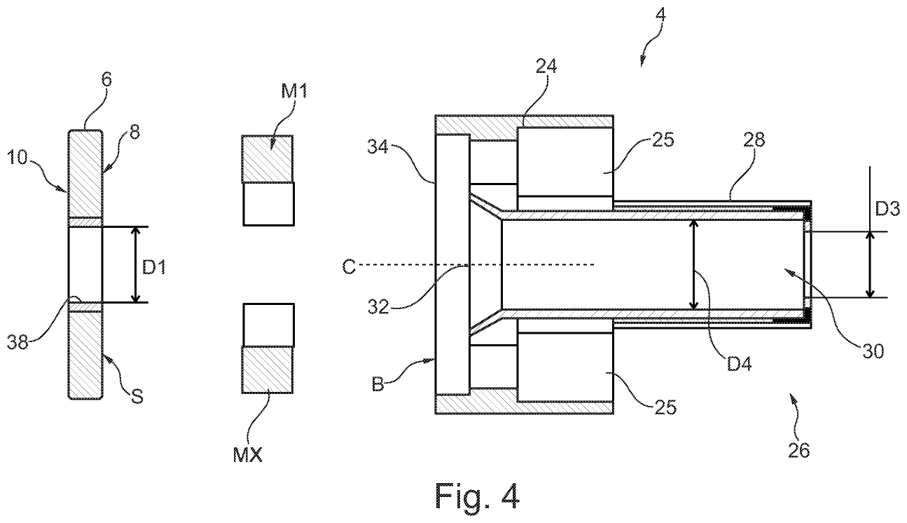

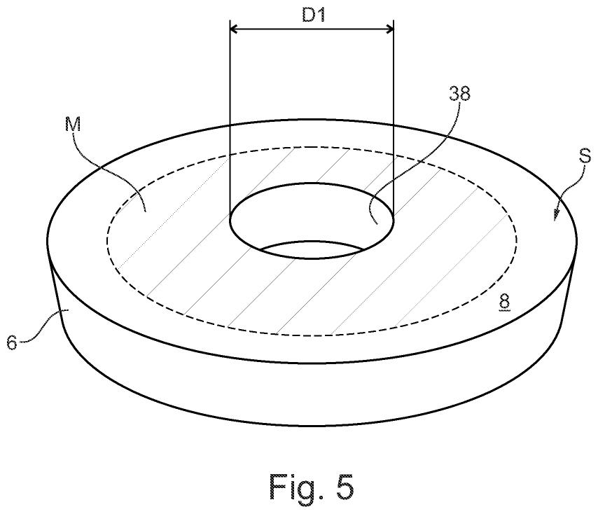

FIG. 1 shows, with the various parts in an exploded view, an arrangement 1 comprising a receiving device 2 for removable attachment of a screw bit holder 4 according to an embodiment of the invention. As also further shown and described below with reference to FIGS. 4-5, the receiving device 2 comprises a disc-shaped platform 6 having a front side 8 and a back side 10. The receiving device 2 is further provided with a centrally extending projection 12, protruding essentially perpendicular from the front side 8 of the disc-shaped platform 6 of the receiving device 2. The centrally extending projection 12 may either be a removable projection or a projection that is fixed to the disc-shaped platform 6 and made in one piece with the platform 6. The projection 12 may also be defined as a protrusion, such as a bump, protuberance, ridge or the similar.

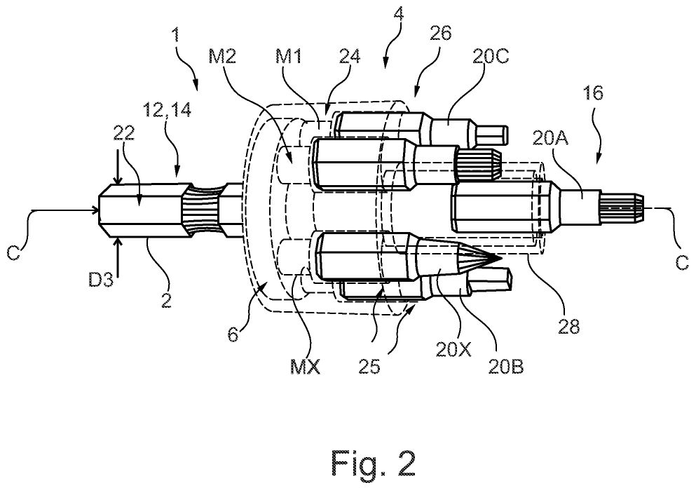

The centrally extending projection 12 may suitable be a longitudinally extending axle, preferably a bit holder axle 14, more preferably a standardized bit holder axle 14. The bit holder axle 14, as shown in FIGS. 1-2, is removably attached to the disc-shaped platform 6 of the receiving device 2 in a preferred embodiment. The bit holder axle 14 has a first end 16 with a recess 18 configured for magnetic attachment of a screw bit 20A, used for the drilling work with a screw driver. The bit holder axle 14 has an opposite second end 22 configured for rigid and fixed attachment to a chuck of a screw driver, preferably an electric screw driver. Once a screw bits holder 4, carrying a plurality of screw bits 20B, 20C . . . 20X, is in its position on the electrical screw driver, the user is as close as possible to the suitable bits 20A, 20B, 20C . . . 20X, in the specific work situation and may easily choose among the bits 20A, 20B, 20C . . . 20X and change to the desired one for carrying out the work.

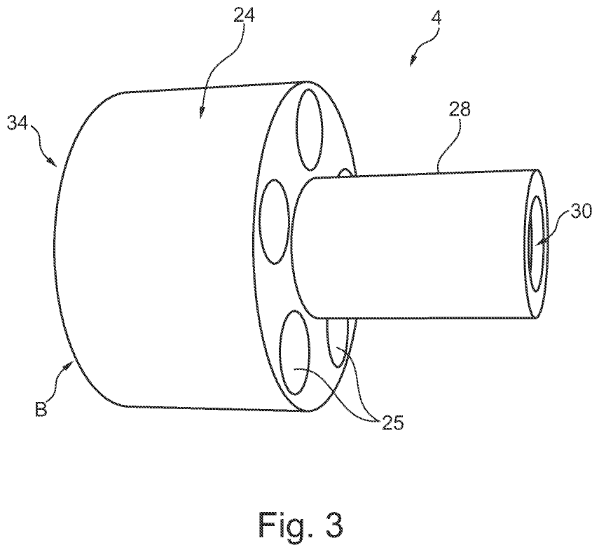

Furthermore, as shown in FIGS. 1-4 and 6-7, the screw bit holder 4 comprises a base portion 24 with apertures 25 at a front side 26 of the screw bit holder for carrying screw bits 20A, 20B, 20C . . . 20X, preferably a plurality of screw bits 20A, 20B, 20C . . . 20X. A longitudinal tube 28, surrounded by the apertures 25, is extending centrally C through the base portion 24. The tube 28 has a through longitudinal hole 30, with an opening at the end 32 at the back side 34 and extends above the base portion 24 at the front side 26.

The centrally extending projection 12 of the receiving device 2 is preferably configured for removable attachment to the screw bit holder 4. Suitably, the first end 16 of the centrally extending projection 12 is configured to extend in at least a part of the through longitudinal hole 30 of the screw bit holder 4. Preferably, the first end 16 of the centrally extending projection is configured to extend through the longitudinal hole 30 and out from the front side 26 of the screw bit holder 4 as shown in FIG. 2.

With respect to the receiving device 2, at least a part of the disc-shaped platform 6 is made of a magnetic material or at least a part of a surface S at a front side 8 of the platform 6 surrounding the projection 12 is provided with at least one magnetic element M. The platform 6 of the receiving device 2 can preferably have a circular shape as shown in FIGS. 1, 2 and 4-7, preferably provided with a continuous circular magnetic element M surrounding the projection 12. However, most preferably the platform 6 may be completely made of magnetic material which can be an advantage from a production efficiency perspective and a cost efficient view. A circular platform 6 is easier to fit with a surface of a connecting device, such as the back side 34 of the screw bit holder 4, with corresponding circular shape, than non-circular forms.

The screw bit holder 4 is provided with at least one magnetic element M1, M2 . . . . MX, adjacent the bottom of the apertures 25 towards a back side 34 of the screw bit holder 4, as shown in FIGS. 1-2, 4 and 7. At least a part of a surface at the bottom B of the screw bit holder, surrounding the opening of the through longitudinal hole 30 at the end at the back side 34, is provided with at least one magnetic element M1, M2 . . . . MX. Preferably, the surface at the bottom of the screw bit holder 4 is provided with a plurality of magnetic elements M1, M2 . . . . MX in a circular formation, or with a continuous circular magnetic element (not shown), surrounding the opening of the through longitudinal hole 30. The circular formation at the bottom of the screw bit holder 4 is easier to fit with a surface of the receiving device 2 with corresponding circular shape and size.

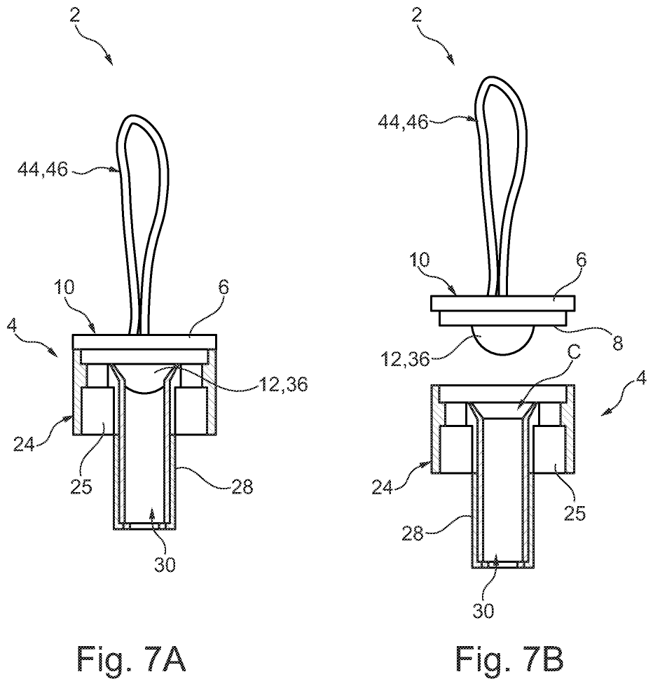

In FIGS. 1-2, 4 and 6-7 it is illustrated that the back side of the screw bit holder 4 is provided with a cavity C configured for removable attachment of the centrally extending projection 12 of the receiving device 2. The cavity C is provided with a shape that fits the shape of corresponding projection 12 of the receiving device 2. As a result, the circular disc-shaped platform 6 fits in a compartment formed in the cavity C with the corresponding shape at the backside 34 of the bit holder 4 as shown in FIGS. 1, 2, 4 and 6. In FIGS. 7A-B, a projection in shape of a bump or a dome 36, fits in a compartment with the corresponding shape at the backside 34 of the bit holder 4.

According to a preferred embodiment, the cavity C of the screw bit holder 4 is a through longitudinal hole 30. Preferably, the centrally extending projection 12, protruding essentially perpendicular from the disc-shaped platform 6 of the receiving device 2, is a bit holder axle 14. Preferably, the bit holder axle 14 is a standardized bit holder axle, configured for extending in the through longitudinal hole 30 of the screw bit holder 4. As a result, the arrangement that can be used in existing equipment on the market, the user can use his/her ordinary screw driver and preferably also a standardized bit holder axle 14.

The magnetic elements M on the receiving device 2, or the magnetic platform 6 of the receiving device 2, and the screw bit holder 4 are positioned adjacent each other such that the screw bit holder 4 and the receiving device 6 are removable attached to each other by the magnetic force. The magnetic attachment between the receiving device 2 and the screw bits holder 4 should also be set such that it is easy to remove the screw bits holder 4 from the receiving device 2 by overcoming the magnetic force exerted by the magnets by hand. The magnetic attachment also provides for a quick and easy exchange of screw bit holders, by moving the screw bits holders 4 to and from a storage position for attachment or detachment at an electrical screw driver.

With reference to FIG. 5, the platform 6 of the receiving device 2 has preferably a centrally through hole 38 which diameter D1 is less than the largest diameter D2 of the centrally extending projection 12. The handling will be simplified when providing the receiving device 2 with the platform 6, that can be removably attached to the centrally extending projection 12, preferably a standardized bit holder axle, by bringing on the second end 22 of the bit holder axle 14 into the hole 38 of the platform 6, which has a diameter D3 equal to the diameter D1 of the hole, up to the position of the bit holder axle where the diameter D2 is larger than the diameter D1 of the hole 38 of the disc-shaped platform 6. Consequently, when the receiving device 2 e.g. is mounted on an electric screw driver, the larger diameter D2 of the centrally extending projection 12, preferably a standardized bit holder axle 14, prevents the platform 6 to move further forward towards the first end 16 on the bit holder axle 14.

The diameter of the longitudinal hole 30 at the recess 18 at the first end 16, at the upper part of the centrally extending projection 12, is the same diameter D3 at the second end 22 of the bit holder axle 14. Since the inner diameter D4 of the longitudinal hole 30 of the tube 28 is larger, from below the recess 18 at the first end 16 to the end 32 at the back side 34 of the screw bit holder 4, the screw bit holder 4 can be brought over the bit holder axle 14 until the hole at the recess 18 with the smaller diameter D3 meets the larger diameter D2 of the bit holder axle 14. Hence, the bit holder 4 will be prevented from moving further down on the bit holder axle 14.

According to yet a further aspect of the invention the receiving device 2 is configured for removable attachment to a drill chuck (not shown) of an electric screw driver. Although, other applications for the receiving device 2 are possible, the receiving device 2 is specifically suitable for attachment to a drill chuck of an electric screw driver.

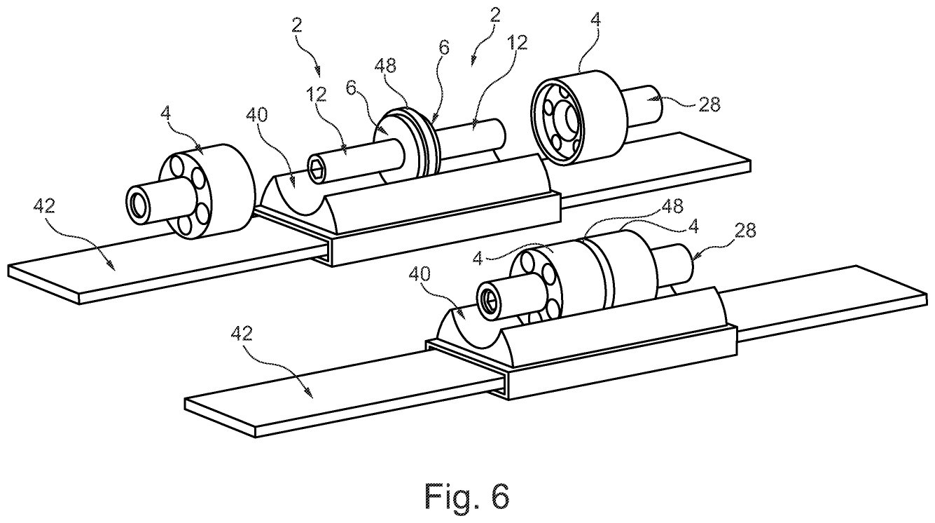

FIGS. 6 and 7A-B illustrates storage devices for screw bit holders 4 that can be provided with at least one receiving device 2, according to embodiments of the invention, configured for removable attachment of a screw bit holder 4. The same reference numerals are used for the corresponding features as shown and described with reference to FIGS. 1-5. As a result, storage devices for the screw bit holders 4 can be provided, that can be handled individually, and that simplify the handling and immediate accessibility of bits 20A, 20B . . . 20X that is needed in a given work situation. Hence, screw bits holders 4 comprising a plurality of bits 20A, 20B . . . 20X that are not in use for the moment can be stored in an organized and easily accessible way, in order to be ready for use by quick attachment in a position on the electrical screw driver.

FIG. 6 shows two receiving devices 2 that are firmly attached to a supporting surface 40, adjacent a portion of the side of the disc-shaped platform 6 of each receiving device 2. In this embodiment, the receiving devices 2 are also fixedly arranged with each back of the platforms 6 towards each other and with a supporting circular disc-shaped wall 48 placed in between the two platforms 6. Furthermore, the centrally extending projection 12 of each receiving device 2, is fixedly attached to the platform, according to this embodiment. The centrally extending projection 12 may suitable be a longitudinally extending axle. The supporting surface 40 can be provided with a cup-shaped curving with a corresponding curvature radius as the curvature radius of the disc-shaped platform 6. The supporting surface 40 may preferably be arranged on belt 42 suitable for wearing around the waist. It is also possible, but not shown in FIG. 6, that a receiving device 2 can be firmly attached with the backside of the disc-shaped platform 6 adjacent a support surface.

FIG. 7A-B shows a receiving device 2 according to yet another embodiment of the invention. A receiving device 2 for removable attachment of a screw bit holder 4 is provided, wherein the receiving device 2 comprises a disc-shaped platform 6 provided with a centrally extending projection 12, protruding essentially perpendicular from the disc-shaped platform 6 of the receiving device 2, at least a part of the disc-shaped platform is made of a magnetic material or at least a part of a surface S surrounding the projection is provided with at least one magnetic element M. According to a preferred embodiment of the invention, a receiving device 2 for removable attachment of a screw bit holder 4 is provided at a front side 8, where an opposite back side 10 is provided with fastening means 44, preferably a keychain 46 or a hook or the similar, whereas the centrally extending projection is configured for removable attachment to a cavity at a back side of a screw bit holder. FIG. 7A shows the receiving device 2 in a connected condition with the screw bit holder 4 and FIG. 7B shows the receiving device 2 in a disconnected condition with the screw bit holder 4. Consequently, the receiving device 2 can be used for storing screw bit holders 4 close to the workman, for instance carried on a belt or attached to a structure close to the workman during ongoing work.

It is to be understood that the present invention is not limited to the embodiments described above and illustrated in the drawings; rather, the skilled person will recognize that many changes and modifications may be made within the scope of the appended claims.

1. An arrangement comprising a receiving device for removable attachment of a screw bit holder, wherein the receiving device comprises a disc-shaped platform having a front side and a back side, provided with a centrally extending projection, protruding essentially perpendicular from the front side of the disc-shaped platform of the receiving device-, at least a part of the disc-shaped platform is made of a magnetic material or at least a part of a surface surrounding the projection (12; 14; 36) is provided with at least one magnetic element, the screw bit holder comprises a base portion with apertures at a front side of the screw bit holder for carrying screw bits, the screw bit holder is provided with at least one magnetic element-adjacent the bottom of the apertures towards a back side of the screw bit holder, the back side of the screw bit holder is provided with a cavity-configured for removable attachment of the centrally extending projection of the receiving device, whereas the magnetic elements, or the magnetic platform of the receiving device, on the receiving device and the screw bit holder are positioned adjacent each other such that the screw bit holder and the receiving device are removable attached to each other by the magnetic force.

2. The arrangement according to claim 1, wherein the platform is circular.

3. The arrangement according to claim 1, wherein the cavity of the screw bit holder is a through longitudinal hole and the centrally extending projection, protruding essentially perpendicular from the disc-shaped platform of the receiving device, is a bit holder axle, extending in the through longitudinal hole.

4. The arrangement according to claim 1, wherein the platform is removable attached to the centrally extending projection, preferably a standardized bit holder axle 14), and the platform has a centrally through hole which diameter is less than the largest diameter of the centrally extending projection.

5. The arrangement according to claim 1, wherein the receiving device is configured for removable attachment to a drill chuck of an electric screw driver.

6. The arrangement according to claim 1, wherein a storage device for bits is provided with at least one receiving device, configured for removable attachment of a screw bit holder, wherein the receiving device is firmly attached to a supporting surface, either adjacent a portion of the side of the disc-shaped platform or at the backside of the disc-shaped platform.

7. A receiving device for removable attachment of a screw bit holder, wherein the receiving device comprises a disc-shaped platform provided with a centrally extending projection at a front side of the disc-shaped platform, protruding essentially perpendicular from the disc-shaped platform of the receiving device, at least a part of the disc-shaped platform is made of a magnetic material or at least a part of a surface surrounding the projection is provided with at least one magnetic element.

8. The receiving device according to claim 7, wherein an opposite back side of the disc-shaped platform is provided with fastening means, wherein the centrally extending projection is configured for removable attachment to a cavity at a back side of a screw bit holder.

9. The arrangement according to claim 1, wherein the platform is a continuous circular magnetic element surrounding the projection.

10. The arrangement according to claim 1, wherein the platform is made of magnetic material.
